(19) United States
(12) Patent Application Publication
(10) Pub. No.: US 2024/0145679 A1
(43) Pub. Date: May 2, 2024

(54) COMPOSITION AND METHOD FOR RECHARGEABLE BATTERY

(71) Applicant: The Research Foundation for the State University of New York, Albany, NY (US)

(72) Inventors: Esther S. Takeuchi, South Setauket, NY (US); Kenneth Takeuchi, South Setauket, NY (US); Amy C. Marschilok, Setauket, NY (US)

(73) Assignee: The Research Foundation for the State University of New York, Albany, NY (US)

(21) Appl. No.: 17/766,501

(22) PCT Filed: Oct. 4, 2020
(86) PCT No.: PCT/US2020/054194

§ 371 Date: Apr. 4, 2022

Related U.S. Application Data
(60) Provisional application No. 62/910,665, filed on Oct. 4, 2019.

(51) Int. Cl. H01M 4/36; H01M 4/04; H01M 4/505; H01M 4/525; H01M 4/58; H01M 4/583; H01M 10/44

(52) U.S. Cl. CPC H01M 4/366; H01M 4/0402; H01M 4/505; H01M 4/525; H01M 4/5815; H01M 4/5835; H01M 10/446; H01M 2004/028

(57) ABSTRACT

A method of preparing a composition for use as a cathode that combines two different cathode materials is disclosed. When utilized in a battery, one cathode material is rechargeable, and the second cathode material has a high capacity with a lower voltage than the first cathode material. The active materials may be combined in several fashions including mixing, layering, deposition, coating, and/or patterning. Such batteries can be tested repeatedly over a specific voltage range and provide high capacity under full discharge at deployment.

### CROSS-REFERENCE TO RELATED APPLICATIONS

This application derives the benefit of the filing date of U.S. Provisional Patent Application No. 62/910,665, filed Oct. 4, 2019. The contents of the provisional application are incorporated by reference in this application.

### BACKGROUND OF THE INVENTION

### 1. Field of the Invention

The present invention relates broadly to rechargeable batteries and, more particularly to a method of preparing a composition for use as an electrode that combines different cathode active materials. The inventive cathode material can be used in a battery where a first cathode material is rechargeable and a second cathode active material that has a high capacity and which has a lower voltage than the voltage of the first cathode active material. An electrode formed with the resulting composite cathode active material can have two cathode active materials, where one is rechargeable and the other has high capacity. Batteries formed with the cathodes fabricated with the composite composition formed with the first and second cathode active materials can be tested before deployment, repeatedly over a specific voltage range, and still provide high capacity under full discharge at deployment.

### 2. Background of the Related Art

The current state of the art of batteries divides batteries into two classes: 1) rechargeable batteries that can be discharged and then charged several times; and 2) primary batteries that are intended for one-time use. Rechargeable batteries have the benefit that they can be used over and over, yet are limited as they typically have lower capacity. Primary batteries have the advantage that they are often made of active materials that have high capacity, enabled to provide long service life in a single use. However, the primary batteries can only be deployed once.

Some battery applications demand unquestionable reliability. Ideally, one would want to test the battery to determine its function prior to deployment to have high confidence in its function. If a rechargeable battery is used, this is possible, but the capacity of the conventional rechargeable battery will be lower. A primary battery cannot be tested prior to use as the battery would be depleted irreversibly.

### SUMMARY OF THE INVENTION

The present invention provides a method of preparing a composition for use as a cathode active material, an electrode, namely, a cathode, formed using the cathode active material, and a battery including a cathode so formed, which overcome the shortcomings of the prior art.

The inventive method includes forming a composition by combining different cathode active materials to form an inventive cathode. When included in a battery, a first cathode material of the inventive cathode is a rechargeable material and a second cathode material is a high capacity material with a lower voltage than the first cathode material. The first and second cathode active materials may be combined in several fashions including mixing, layering and/or patterning, to manufacture the composition and the inventive cathode.

The invention further includes high-capacity batteries with partial rechargeability, constructed with a cathode fabricated from a composition formed according to the inventive method. The inventive cathode comprising the first and second cathode active materials enables the manufacture of batteries formed with such partially rechargeable cathode to be repeatedly tested over a specific voltage range and nevertheless provide high capacity under full discharge at deployment.

### BRIEF DESCRIPTION OF THE DRAWING

The following detailed description of embodiments of the invention will be made in reference to the accompanying drawings. In describing the invention, explanation about related functions or constructions known in the art are omitted for the sake of clearness in understanding the concept of the invention to avoid obscuring the invention with unnecessary detail.

FIG. 1 is a discharge profile of a carbon monofluoride/lithium cobalt oxide (CFx/LCO) composite electrode presenting voltage over capacity (Ah), where the high voltage portion derives from a first cathode active material that is rechargeable, and the lower voltage segment derives from a second high capacity cathode active material that provides high capacity.

FIG. 2a is a voltage vs time plot of a CFₓ/LCO electrode formed with 50:50 rechargeable and high-capacity cathode active materials. In FIG. 2a, line with square indicates a rest state, unmarked line indicates galvanostatic charging in the LCO active voltage region, line with triangle indicates galvanostatic discharge in the LCO active voltage region, and line with circles indicates galvanostatic discharge in the CFx active voltage region at a current of 0.03 mA/cm².

FIG. 2b is a galvanostatic discharge plot of the CFₓ/LCO electrode formed with the 50:50 rechargeable and high-capacity cathode active materials. In FIG. 2b, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

FIG. 2c is a voltage vs time plot of a CFₓ/LCO electrode formed with 75:25 rechargeable and high-capacity cathode active materials. In FIG. 2c, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

FIG. 2d is a galvanostatic discharge plot of the CFₓ/LCO electrode formed with the 75:25 rechargeable and high-capacity cathode active materials. In FIG. 2d, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

FIG. 3a illustrates AC impedance data and equivalent circuit fitting models of a 50:50 CFx/LCO electrode formed according to the invention, before cycling. Line with circle is raw data. Line without circle is fitted result for provided equivalent circuit.

FIG. 3b illustrates AC impedance data and equivalent circuit fitting models of a 50:50 CFx/LCO electrode formed according to the invention, after one cycle targeting the LCO region of 2.8 to 4.1 V vs Li. Line with circle is raw data. Line without circle is fitted result for provided equivalent circuit.

FIG. 3c illustrates AC impedance data and equivalent circuit fitting models of a 50:50 CFx/LCO electrode formed according to the invention, after two additional cycles between 2.8 and 4.1 V followed by discharge to 2.0 V vs Li. Line with circle is raw data. Line without circle is fitted result for provided equivalent circuit.

FIG. 4a illustrates AC impedance data and equivalent circuit fitting models of a 75:25 CFx/LCO electrode before cycling. Line with circle is raw data. Line without circle is fitted result for provided equivalent circuit.

FIG. 4b illustrates AC impedance data and equivalent circuit fitting models of a 75:25 CFx/LCO electrode after one cycle targeting the LCO region of 2.8 to 4.1 V vs Li (b). Line with circle is raw data. Line without circle is fitted result for provided equivalent circuit.

FIG. 4c illustrates AC impedance data and equivalent circuit fitting models of a 75:25 CFx/LCO electrode after two additional cycles between 2.8 and 4.1 V followed by discharge to 2.0 V vs Li. Line with circle is raw data. Line without circle is fitted result for provided equivalent circuit.

FIG. 5a illustrates the results of cyclic voltammetry testing of CFx/LCO electrode with active mass ratios of 50:50.

FIG. 5b illustrates the results of cyclic voltammetry testing of CFx/LCO electrode with active mass ratios of 75:25.

FIG. 5c illustrates the results of cyclic voltammetry testing of CFx/LCO electrode with active mass ratios of 90:10. Electrodes were cycled against Li metal at a sweep rate of 0.1 mV/s. The LCO region between 3.0 and 4.2 V vs Li was cycled twice, followed by a lower sweep to 2.0 V, and then a final cycle of the LCO region. Line with circle is charge, line without circle is discharge.

FIGS. 6a, 6b, 6c, 6d, 6e and 6f together illustrate the results of electrochemical cycling intermittently accessing the CFx voltage region of a 50:50 CFx/LCO electrode outlining the duty cycle of the cell with respect to time where line with triangle corresponds to charge and line with square corresponds to discharge (FIG. 6a), galvanostatic cycling of all steps where line with triangle corresponds to charge of the LCO region, line with square corresponds to discharge of the LCO region, and green corresponds to discharge of CFx (FIG. 6b), charging of the LCO region (FIG. 6c), discharging of the LCO region (FIG. 6d), discharging of the CFx region (FIG. 6e), capacity and capacity retention where line with triangle corresponds to charge, line with circle corresponds to discharge, and line without symbols corresponds to Coulombic efficiency (FIG. 6f). Line with triangle

FIGS. 7a, 7b, 7c, 7d, 7e, 7f together illustrate the results of electrochemical cycling intermittently accessing the CFx voltage region of a 75:25 CFx/LCO electrode, outlining the duty cycle of the cell with respect to time where line with triangle corresponds to charge and line with square corresponds to discharge (FIG. 7a), galvanostatic cycling of all steps where line with triangle corresponds to charge of the LCO region, line with square corresponds to discharge of the LCO region, and line without symbol corresponds to discharge of CFx (FIG. 7b), charging of the LCO region (FIG. 7c), discharging of the LCO region (FIG. 7d), discharging of the CFx region (FIG. 7e), capacity and capacity retention where line with triangle corresponds to charge, line with circle corresponds to discharge, and line without symbols corresponds to Coulombic efficiency (FIG. 6f). Line with triangle (FIG. 7f).

FIGS. 8a, 8b, 8c, 8d, 8e, 8f together illustrate the results of electrochemical cycling intermittently accessing the CFx voltage region of a 90:10 CFx/LCO electrode, outlining the duty cycle of the cell with respect to time where line with triangle corresponds to charge and line with square corresponds to discharge (FIG. 8a), galvanostatic cycling of all steps where line with triangle corresponds to charge of the LCO region, line with square corresponds to discharge of the LCO region, and line without symbol corresponds to discharge of CFx (FIG. 8b), charging of the LCO region (FIG. 8c), discharging of the LCO region (FIG. 8d), discharging of the CFx region (FIG. 8e), capacity and capacity retention where line with triangle corresponds to charge, line with circle corresponds to discharge, and line without symbols corresponds to Coulombic efficiency (FIG. 6f). Line with triangle (FIG. 8f).

FIG. 9 Illustrates galvanostatic discharge of CFx/LVO electrodes based on electrode composition discharged at 0.03 mA/cm2 where line without symbol represents 20:60:15:5 percent by mass of CFx, LVO, carbon, and polyvinylidenefluoride, respectively; line with square symbol represents 40:40:15:5 percent by mass of CFx, LVO, carbon, and polyvinylidenefluoride, respectively, line with triangle represents 60:20:15:5 percent by mass of CFx, LVO, carbon, and polyvinylidenefluoride, respectively, and line with circle represents 80:0:15:5 percent by mass of CFx, LVO, carbon, and polyvinylidenefluoride, respectively,

### DETAILED DESCRIPTION OF THE INVENTION

Embodiments of the invention are provided to disclose a method of manufacturing a composition from different cathode active materials, fabricating electrodes, and particularly cathodes using the composition comprising the different cathode active materials, and a rechargeable battery that includes a cathode fabricated from the inventive composition.

In one embodiment a first cathode active material is rechargeable, and a second cathode active material is a high capacity cathode material with a lower voltage than the voltage of the first cathode active material. The first rechargeable cathode active material and the second high-capacity cathode active material may be combined in several fashions including mixing, layering coating, depositing, or patterning. Patterning is defined as organization of the two materials with respect to a geometry. This geometry can be reflected by a variety of forms, both two dimensional and three dimensional. These forms can include columnar, spherical, rectangular, rhombohedral, mesh-type organizations of the two active materials. Thus, the inventive method yields a composition that when fabricated as a cathode enables high-capacity batteries with partial rechargeability. These high capacity batteries with partial rechargeability can be tested repeatedly over a specific voltage range and nevertheless provide high capacity under full discharge.

The first cathode active material present in the disclosed composition comprises high voltage material that is rechargeable; the high voltage material can be discharged and charged more than one time. The second cathode active material present in the disclosed composition has a high capacity at a lower voltage than the first cathode active material, and can be non-rechargeable. Additionally, the second cathode active material may act purely as a primary active material. Alternatively, the second cathode active material also may have a characteristic of being rechargeable.

Accordingly, a battery with a cathode formed with the composition prepared according to the invention, with at least two (preferably different) cathode active materials (one rechargeable, the other high capacity), provides higher overall capacity than a conventional rechargeable battery alone.

Furthermore, the inventive battery manufactured with a cathode fabricated with a composition formed with a first rechargeable cathode active material and a second high-capacity cathode active material, with a lower voltage than the first cathode active material, prepared according to the inventive method, is adapted to be tested such that the high voltage material is discharged and charged repeatedly without depleting the high capacity lower voltage material. As such, batteries manufactured with the composite cathodes fabricated from the composition formed according to the inventive method, provide limited capacity rechargeability.

The battery with cathode formed a composition of the two cathode active materials provides a solution for high reliability battery applications. The inventive battery can be tested such that the high voltage rechargeable material is cycled to verify that the battery function, construction, and internal resistance are all within the desired parameters. This cyclical testing can be carried out in such a way that the high capacity lower voltage material is not fully depleted. High-capacity batteries formed with the inventive technology allow for interrogation ensuring high reliability and high energy density.

Preparation of the Cathode:

The two cathode active materials are fully combined by mixing so that they are uniformly dispersed within a composite cathode active material composition. The two active materials alternatively may be patterned such that the different cathode active materials are not uniformly dispersed, but are arranged in regional domains throughout a composite cathode structure. These domains are organized throughout the thickness or area of the cathode fabricated according to the inventive method. The inventive composition produces discrete layers of the different cathode active materials, where one material is layered on top of the other material.

Rechargeable cathode active materials include transition metal oxides, phosphates, pyrophosphates, silicates and related materials showing high voltage and electrochemical reversibility including materials based on multiple transition metals or anion types. High capacity cathode active materials include transition metal sulfides, sulfur, carbon monofluoride, transition metal oxides, transition metal phosphates and related materials.

### EXAMPLES

1) Combine lithium vanadium oxide, LiV₃O₈ (rechargeable cathode active material) with carbon mono fluoride, CFₓ, (high capacity cathode active material) for a composition from which a cathode can be fabricated.
2) Combine vanadium oxide, V₂O₅ (rechargeable cathode active material) with iron disulfide, FeS₂ (high capacity cathode active material) for a composition from which a cathode can be fabricated.
3) Combine alpha-manganese oxide, alpha-MnO₂, (rechargeable cathode active material) with FeS₂ (high-capacity cathode active material) for a composition from which a cathode can be fabricated.
4) Lithium nickel manganese cobalt oxide, LiNiₓMn_{y}Co_{z}O₂ (rechargeable cathode active material) with carbon monofluoride, CFₓ, (high-capacity cathode active material) for a composition from which a cathode can be fabricated.

The impact of this inventive composite, electrode (e.g., cathode) fabricated therefrom, and battery designed/manufactured with the composite cathode is significant for high reliability applications. The inventive battery can be tested prior to deployment, yet still deliver higher capacity than is possible for a rechargeable battery. Thus, energy density is increased in a practical battery, constructed with a cathode fabricated from the composition formed according to the inventive principles, while still allowing functional interrogation of the battery.

Inventors of this application have verified the efficacy of the inventive method, composition formed thereby, cathode fabricated from the inventive composition and battery manufactured with the inventive electrode. Carbon monofluoride (CFₓ)/lithium cobalt oxide (LCO) composite electrodes were fabricated using an Al foil substrate, in accordance with inventive principles.

In doing so, three ratios of the CFx to LCO were used: 50:50, 75:25, 90:10. The electrodes so formed contained conductive carbon additive (15 wt %) and polyvinylidene difluoride (PVDF) binder (5 wt %). A coin type cell configuration was used to implement electrochemical testing, using a Li metal anode in a 1 M LiBF₄ in 50/50 propylene carbonate (PC): dimethyl carbonate (DMC) electrolyte, in reliance upon a computerized testing system. For that matter, thick higher density electrodes formulations were also prepared where the materials were compressed into pellet-like configurations.

Initial Electrochemistry

Initial electrochemistry for examples was conducted to verify battery function, “proper” battery construction, and battery internal resistance. Battery function is defined as open circuit voltage, operating voltage, and delivered capacity. Proper battery construction can be verified through conducting a specific electrochemical test that is representative of the battery design, where the open circuit voltage, operating voltage and delivered capacity are known and predicted. Battery internal resistance can be verified through a comparison of the open circuit voltage and the loaded voltage under a specified current, as well as methods including electrochemical impedance spectroscopy.

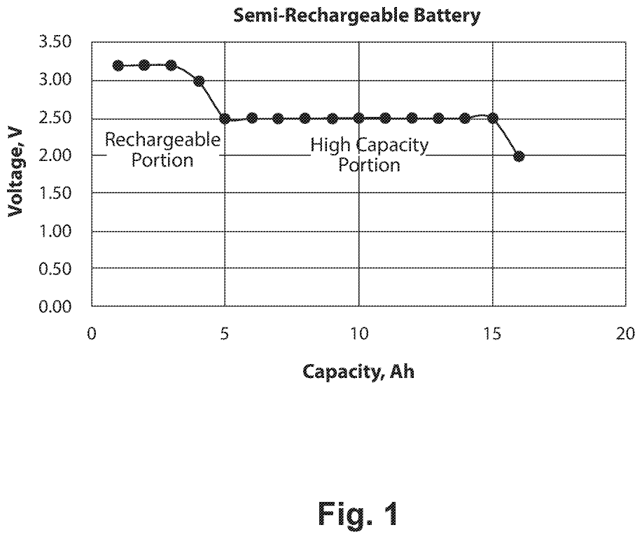

FIG. 1 is a discharge profile of a CFx/LCO composite electrode presenting voltage over capacity (Ah), where the high voltage portion derives from a first cathode active material that is rechargeable, and the lower voltage segment derives from a second high capacity cathode active material that provides high capacity.

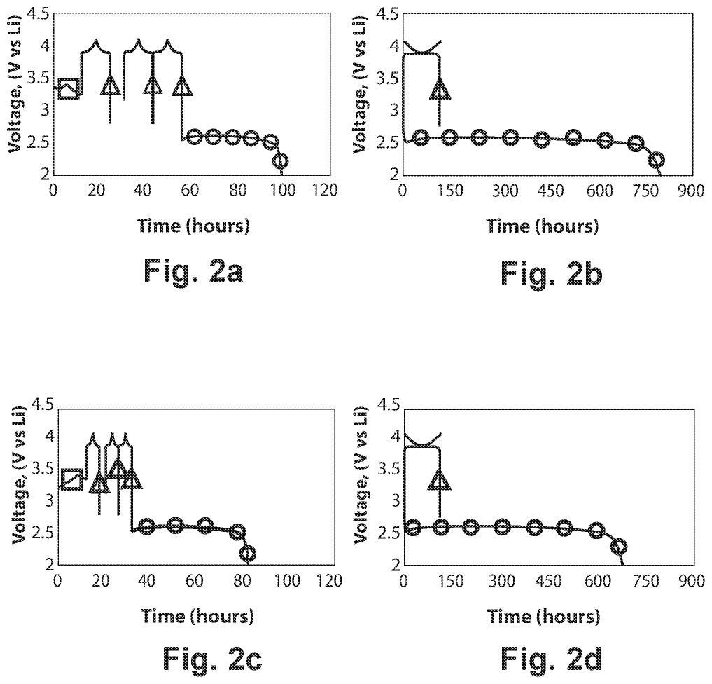

FIGS. 2a-2f together present a voltage vs time plot, and a galvanostatic discharge plot of a 50:50 composite electrode (FIGS. 2a, 2b), a 75:25 composite electrode (FIGS. 2c, 2d), and a 90:10 composite electrode (FIGS. 2e, 2f) CFₓ/LCO electrode.

FIG. 2a is a voltage vs time plot of a CFₓ/LCO electrode formed with 50:50 rechargeable and high-capacity cathode active materials. In FIG. 2a, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

FIG. 2b is a galvanostatic discharge plot of the CFₓ/LCO electrode formed with the 50:50 rechargeable and high-capacity cathode active materials. In FIG. 2b, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

FIG. 2c is a voltage vs time plot of a CFₓ/LCO electrode formed with 75:25 rechargeable and high-capacity cathode active materials. In FIG. 2c, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

FIG. 2d is a galvanostatic discharge plot of the CFₓ/LCO electrode formed with the 75:25 rechargeable and high-capacity cathode active materials. In FIG. 2d, line with square indicates a rest state, unmarked line indicates galvanostatic charging in the LCO active voltage region, line with triangle indicates galvanostatic discharge in the LCO active voltage region, and line with circles indicates galvanostatic discharge in the CFₓ active voltage region at a current of 0.03 mA/cm².

As shown in FIGS. 2, a discharge profile of a CFₓ/LCO (carbon monofluoride/lithium cobalt oxide) composite electrode can be divided into two domains: the LCO active region, from roughly 3.8 to 4.1 V vs Li, and the CFₓ active region, from roughly 2.8 V and below. The first three cycles targeting the LCO region showed stable discharge capacities of 113, 113, and 113 mAh/g, normalized by an amount of LCO in the electrode, as reflected in FIG. 2b.

Discharging the cell from 2.8 to 2.0 V vs Li accessed the CFₓ material and delivered a capacity of 787 mAh/g, normalized by the amount of CFₓ in the electrode. These values approach the theoretical capacities of these two materials of 274 mAh/g and 865 mAh/g for LCO and CFₓ, respectively. Nitta, N.; Wu, F.; Lee, J. T.; Yushin, G., Li-ion battery materials: present and future. Materials Today 2015, 18 (5), 252-264; Zhang, Q.; Takeuchi, K. J.; Takeuchi, E. S.; Marschilok, A. C., Progress towards high-power Li/CFₓ batteries: electrode architectures using carbon nanotubes with CFx. Physical Chemistry Chemical Physics 2015, 17 (35), 22504-22518.

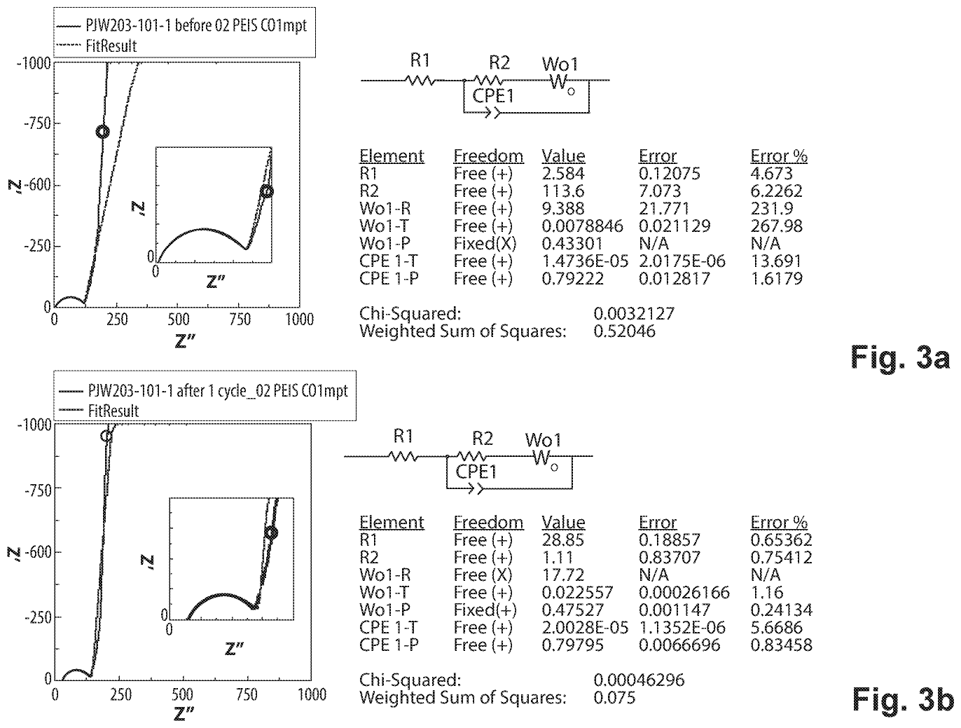

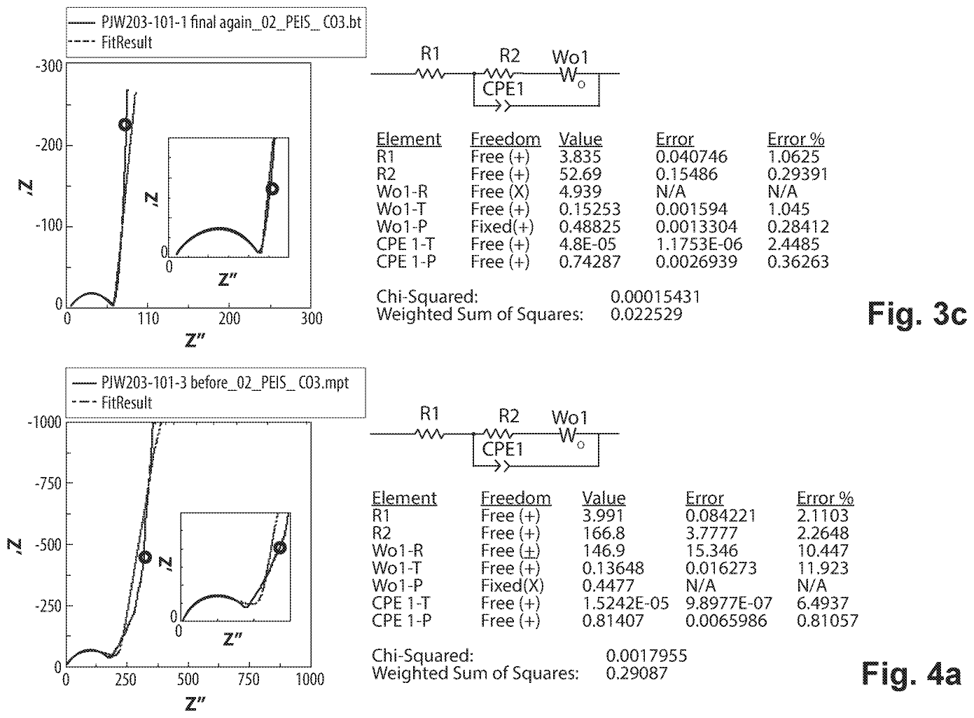

Moreover, an increase in voltage observed after initially accessing the CFₓ region indicates formation of conductive carbon as CFₓ irreversibly reduces into graphite and LiF. This phenomena is echoed in AC impedance data taken before cycling, after the first cycle, and again after discharge to 2.0 V. R_{ct} decreases from 111 to 53 ohms only after discharge to 2.0 V, supporting the claim of the formation of a more conductive species, as depicted in FIGS. 3a, 3b and 3c. These figures present AC impedance data and equivalent circuit fitting models of a 50:50 CFₓ/LCO electrode before cycling (FIG. 3a), after one cycle targeting the LCO region of 2.8 to 4.1 V vs Li (FIG. 3b), and after two additional cycles between 2.8 and 4.1 V followed by discharge to 2.0 V vs Li (FIG. 3c). In FIGS. 3a-3c, line with circle is raw data and line without circle is fitted result for provided equivalent circuit.

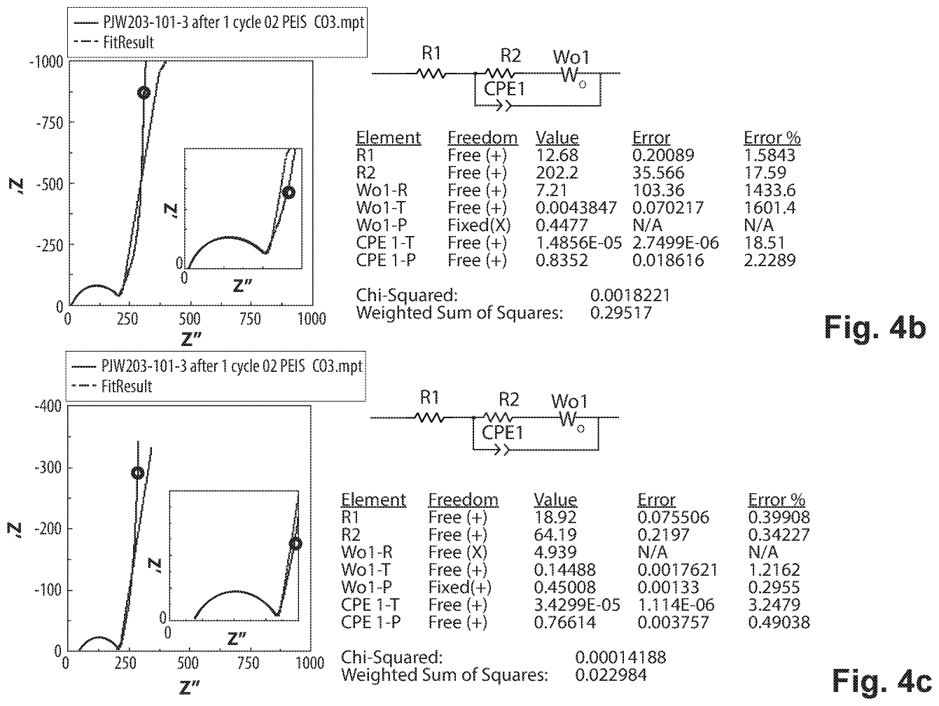

Additional AC impedance data was collected. FIG. 4 together present AC impedance data and equivalent circuit fitting models of a 75:25 CFₓ/LCO electrode before cycling (FIG. 4a), after one cycle targeting the LCO region of 2.8 to 4.1 V vs Li (FIG. 4b), and after two additional cycles between 2.8 and 4.1 V followed by discharge to 2.0 V vs Li (FIG. 4c). In FIGS. 4a-4c, line with circle is raw data and line without circle is fitted result for provided equivalent circuit.

This allows for capacity delivered between the voltage window of 3.0 to 4.2 V to be attributed to LCO activity and capacity delivered below 3.0 V to be attributed to CFₓ activity. The electrochemical behavior of the cell demonstrates the repeated ability to cycle the high voltage constituent in the cathode while holding the single discharge material (CFₓ) in reserve until needed.

The formation of conductive species during the reduction of CFₓ, and the large voltage differences between the electrochemical plateaus of CFₓ and LCO showed that CFₓ/LCO electrodes could allow intermittent access of the CFₓ region. That is, CFₓ/LCO cells were cycled with a duty cycle that begin with two galvanostatic cycles between 2.8 and 4.1 V followed by a discharge step below 2.8 V until 100 mAh/g was delivered at a real current density of 0.03 mA/cm2. These steps were repeated until a voltage of 2.0 V was achieved upon discharge.

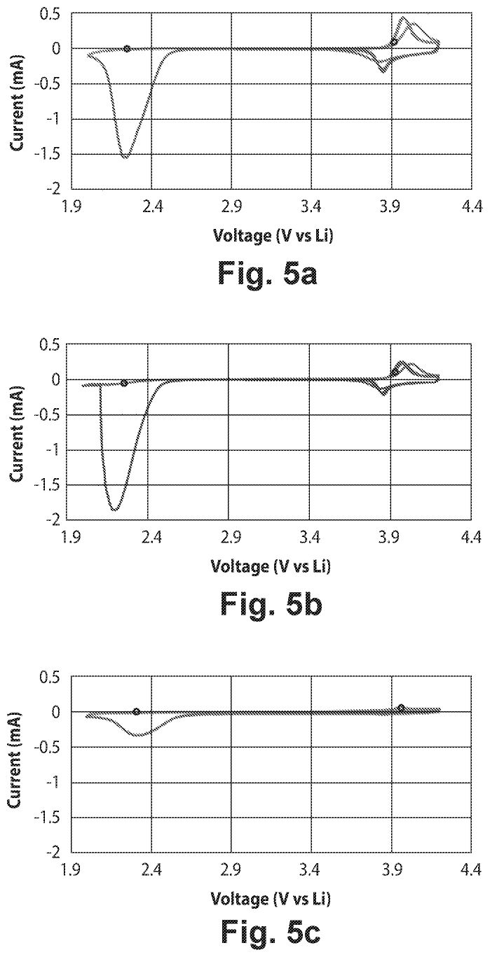

FIGS. 5a, 5b and 5c illustrate the results of cyclic voltammetry testing of CFx/LCO electrode with active mass ratios of 50:50, the results of cyclic voltammetry testing of CFx/LCO electrode with active mass ratios of 75:25 and the results of cyclic voltammetry testing of CFx/LCO electrode with active mass ratios of 90:10. Electrodes were cycled against Li metal at a sweep rate of 0.1 mV/s. The LCO region between 3.0 and 4.2 V vs Li was cycled twice, followed by a lower sweep to 2.0 V, and then a final cycle of the LCO region. Line with circle is charge, line without circle is discharge

The CFx region shown in FIGS. 5a, 5b, 5c, was accessed 9 times before the system reached 2.0 V vs Li for a total capacity of 803 mAh/g of CFx. This is comparable to the capacity of a fully discharged CFx/LCO cell, as depicted in FIG. 1. Likewise, the system exhibited stable 96.2% capacity retention after 18 cycles of the LCO region, as found in Table 1, below.

TABLE 1
Tabulated cyclic voltammetry values of a 50:50 CFx/LCO electrode. Peak current
(Ip) and curve area values were calculated using leading edge analysis.

| | | Charge | | | | | Discharge | | | | | | |
|---|---|---|---|---|---|---|---|---|---|---|---|---|---|
| | | | | | Area | Area | | | | Area | Area | | |
| | | | mA/g of | | Under | Under | | mA/g of | | Under | Under | | |
| | Active | ip | active | | Curve | Curve | ip | active | | Curve | Curve | | |
| Cycle | Material | (mA) | material | E_peak | (mC) | (C/g) | (mA) | material | E_peak | (mC) | (C/g) | dE | E1/2 |
| 1.00 | LCO | 0.43 | 339.70 | 4.20 | 619.10 | 494.49 | 0.21 | 169.25 | 3.85 | 619.10 | 494.49 | 0.35 | 4.02 |
| 2.00 | LCO | 0.45 | 355.83 | 4.20 | 604.70 | 482.99 | 0.12 | 209.90 | 3.85 | 604.70 | 482.99 | 0.35 | 4.02 |
| 3.00 | LCO | 0.43 | 341.13 | 4.20 | 586.60 | 468.53 | 0.16 | 126.44 | 3.85 | 586.60 | 468.53 | 0.35 | 4.02 |
| 3.00 | CFx | | | | | 0.00 | 1.54 | 1230.03 | 2.24 | 3610.00 | 2883.39 | | |
| 4.00 | LCO | 0.34 | 273.40 | 4.04 | 594.20 | 474.60 | 0.04 | 34.12 | 3.83 | 594.20 | 474.60 | 0.21 | 3.93 |

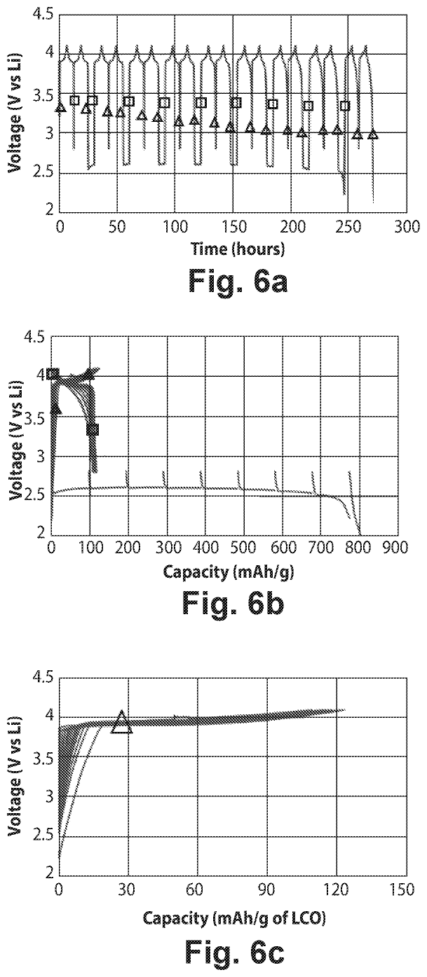

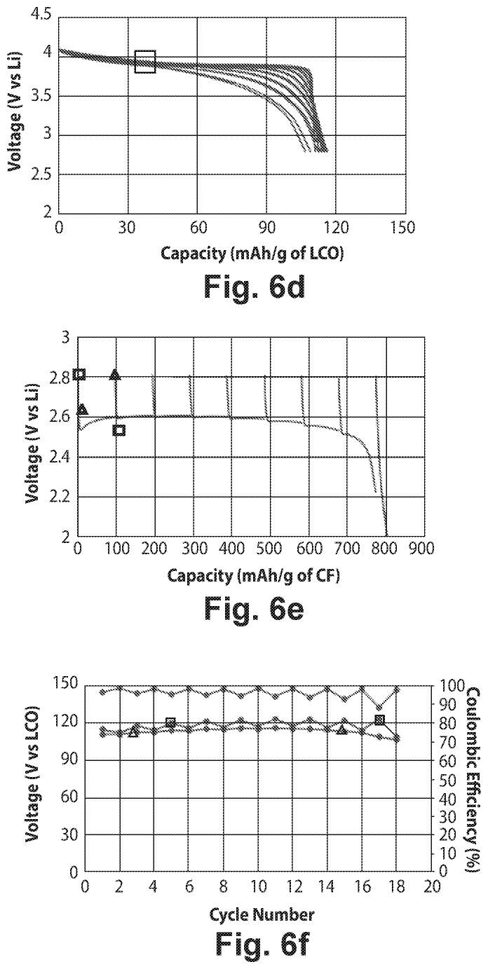

The first charge after accessing the CFx region began lower than the standard 2.8 V, resulting in a higher first charge capacity causing the coulombic efficiency to fluctuate between 96 to 99%, as seen in FIG. 6f.

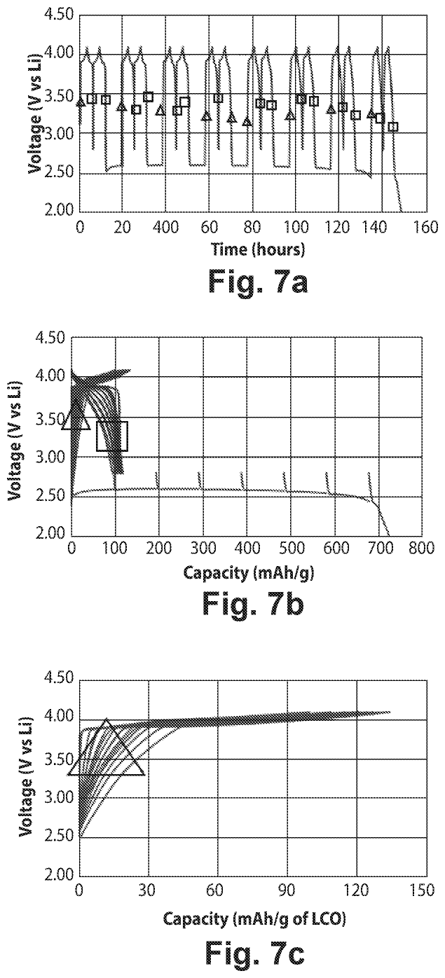

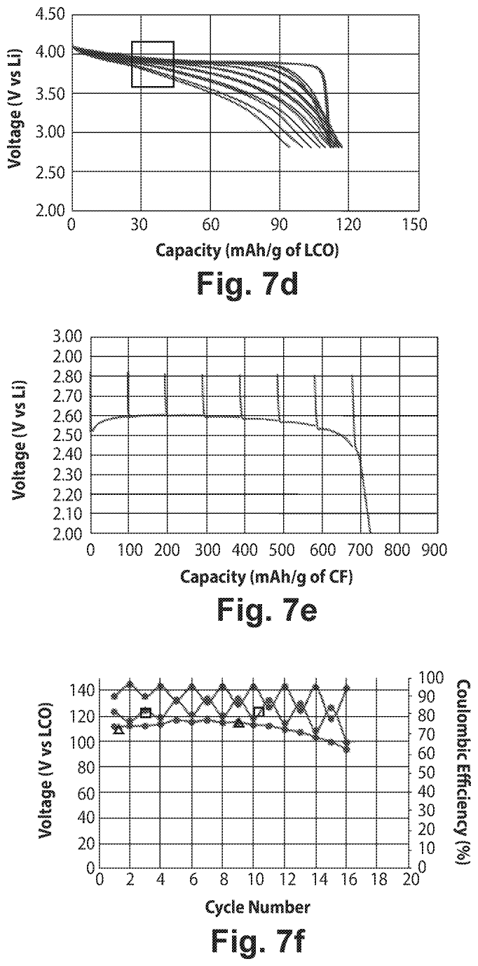

FIGS. 6a-6f present electrochemical cycling intermittently accessing the CFx voltage region of a 50:50 CFx/LCO electrode outlining the duty cycle of the cell with respect to time where line with triangle corresponds to charge and line with square corresponds to discharge (FIG. 6a), galvanostatic cycling of all steps where line with triangle corresponds to charge of the LCO region, line with square corresponds to discharge of the LCO region, and green corresponds to discharge of CFₓ (FIG. 6b), charging of the LCO region (FIG. 6c), discharging of the LCO region (FIG. 6d), discharging of the CFₓ region (FIG. 6e), capacity and capacity retention where line with triangle corresponds to charge, line with circle corresponds to discharge, and line without symbols corresponds to Coulombic efficiency (FIG. 6f). Line with triangle FIGS. 7a-7f present electrochemical cycling intermittently accessing the CFx voltage region of a 75:25 CFx/LCO electrode outlining the duty cycle of the cell with respect to time where line with triangle corresponds to charge and line with square corresponds to discharge (FIG. 7a), galvanostatic cycling of all steps where line with triangle corresponds to charge of the LCO region, line with square corresponds to discharge of the LCO region, and line without symbol corresponds to discharge of CFₓ (FIG. 7b), charging of the LCO region (FIG. 7c), discharging of the LCO region (FIG. 7d), discharging of the CFₓ region (FIG. 7e), capacity and capacity retention where line with triangle corresponds to charge, line with circle corresponds to discharge, and line without symbols corresponds to Coulombic efficiency (FIG. 6f). Line with triangle (FIG. 7f).

These experimental results prove that the CFx and LCO regions can be repeatedly accessed and still deliver capacities akin to standard galvanostatic discharge conditions. Taken as a whole the above electrochemical study of CFx/LCO electrodes prompts study of electrode formulation. Likewise, the system exhibited stable capacity retention after 18 cycles of the LCO region, as found in Table 2, below.

TABLE 2
Tabulated cyclic voltammetry values of a 75:25 CFₓ/LCO electrode. Peak current
(Ip) and curve area values were calculated using leading edge analysis.

| | | Charge | | | | | Discharge | | | | | | |
|---|---|---|---|---|---|---|---|---|---|---|---|---|---|
| | | | | | | Area | | | | | Area | | |
| | | | mA/g of | | Area | Under | | mA/g of | | Area | Under | | |
| | Active | ip | active | | Under | Curve | ip | active | | Under | Curve | | |
| Cycle | Material | (mA) | material | E_peak | Curve | (C/g) | (mA) | material | E_peak | Curve | (C/g) | dE | E1/2 |
| 1.00 | LCO | 0.25 | 427.47 | 4.20 | 325.60 | 555.63 | 0.15 | 258.02 | 3.86 | 106.80 | 182.25 | 0.34 | 4.03 |
| 2.00 | LCO | 0.23 | 388.05 | 4.20 | 324.00 | 552.90 | 0.12 | 209.90 | 3.85 | 98.46 | 168.02 | 0.35 | 4.03 |
| 3.00 | LCO | 0.25 | 421.16 | 4.20 | 313.00 | 534.13 | 0.11 | 188.40 | 3.85 | 83.61 | 142.68 | 0.35 | 4.02 |
| 3.00 | CFx | | | | | 0.00 | 1.85 | 1053.47 | 2.20 | 4033.00 | 2294.08 | −2.20 | 1.10 |
| 4.00 | LCO | 0.21 | 353.24 | 4.20 | 321.40 | 548.46 | 0.05 | 91.55 | 3.84 | 55.48 | 94.68 | 0.36 | 4.02 |

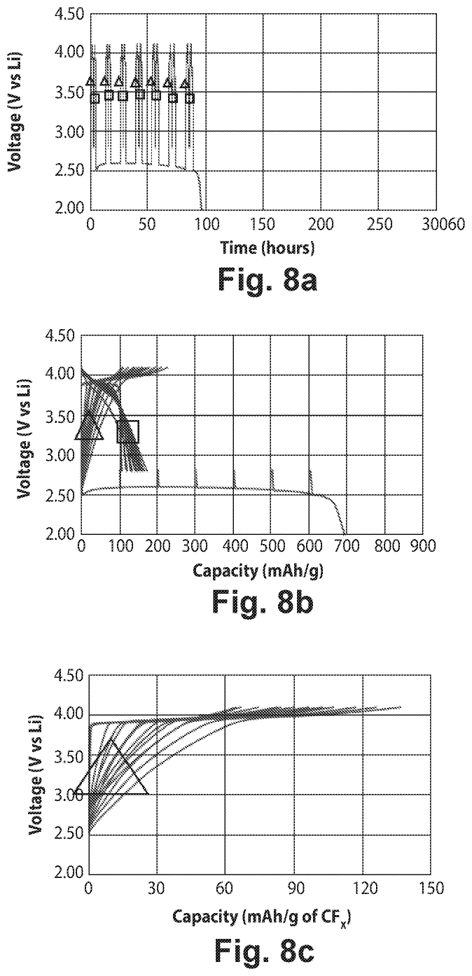

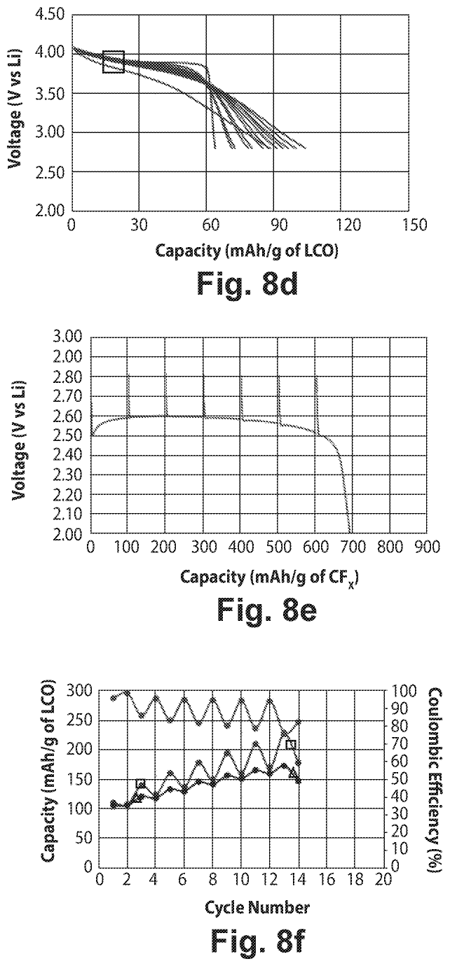

FIGS. 8a-f present electrochemical cycling intermittently accessing the CFₓ voltage region of a 90:10 CFₓ/LCO electrode outlining the duty cycle of the cell with respect to time where line with triangle corresponds to charge and line with square corresponds to discharge (FIG. 8a), galvanostatic cycling of all steps where line with triangle corresponds to charge of the LCO region, line with square corresponds to discharge of the LCO region, and line without symbol corresponds to discharge of CFₓ (FIG. 8b), charging of the LCO region (FIG. 8c), discharging of the LCO region (FIG. 8d), discharging of the CFx region (FIG. 8e), capacity and capacity retention where line with triangle corresponds to charge, line with circle corresponds to discharge, and line without symbols corresponds to Coulombic efficiency (FIG. 6f). Line with triangle (FIG. 8f),

These experimental results prove that the CFₓ and LCO regions can be repeatedly accessed and still deliver capacities akin to standard galvanostatic discharge conditions. Taken as a whole the above electrochemical study of CFₓ/LCO electrodes prompts study of electrode formulation. Likewise, the system exhibited stable 96.2% capacity retention after 18 cycles of the LCO region, as found in Table 3, below.

TABLE 3
Tabulated cyclic voltammetry values of a 75:25 CFₓ/LCO electrode.
Peak current (Ip) and curve area values were calculated.

| | | Charge | | | | | Discharge | | | | | | |
|---|---|---|---|---|---|---|---|---|---|---|---|---|---|
| | | | | | | Area | | | | | Area | | |
| | | | mA/g of | | Area | Under | | mA/g of | | Area | Under | | |
| | Active | ip | active | | Under | Curve | ip | active | | Under | Curve | | |
| Cycle | Material | (mA) | material | E_peak | Curve | (C/g) | (mA) | material | E_peak | Curve | (C/g) | dE | E1/2 |
| 1.00 | LCO | 0.04 | 182.76 | 4.20 | 85.86 | 354.21 | 0.01 | 51.94 | 3.85 | 16.29 | 67.20 | 0.35 | 4.03 |
| 2.00 | LCO | 0.00 | 0.41 | 3.83 | 0.73 | 3.00 | 0.00 | 2.06 | 3.73 | 20.14 | 83.09 | 0.11 | 3.78 |
| 3.00 | LCO | 0.00 | 0.83 | 3.99 | 4.70 | 19.40 | 0.00 | 0.00 | 0.00 | 0.00 | 0.00 | 3.99 | 2.00 |
| 3.00 | CFx | | | | | 0.00 | 0.29 | 133.71 | 2.31 | 854.50 | 391.69 | | |
| 4.00 | LCO | 0.00 | 1.24 | 3.87 | 6.60 | 27.21 | 0.00 | 1.24 | 3.26 | 13.83 | 57.05 | 0.61 | 3.56 |

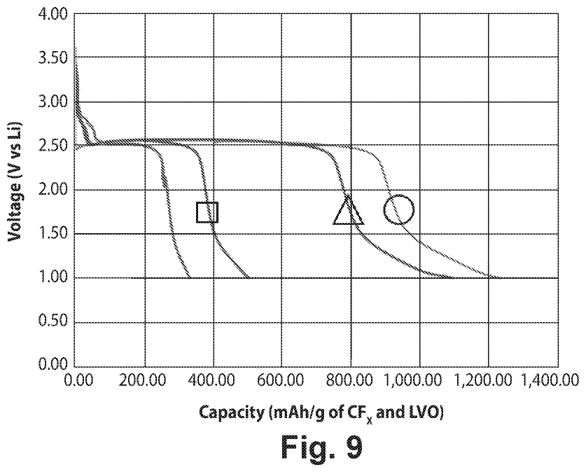

FIG. 9 Illustrates galvanostatic discharge of CFx/LVO electrodes based on electrode composition discharged at 0.03 mA/cm2. cm² where line without symbol represents 20:60:15:5 percent by mass of CFx, LVO, carbon, and polyvinylidenefluoride, respectively; line with square symbol represents 40:40:15:5 percent by mass of CFx, LVO, carbon, and polyvinylidenefluoride, respectively, line with triangle represents 60:20:15:5 percent by mass of CFx, LVO, carbon, and polyvinylidenefluoride, respectively, and line with circle represents 80:0:15:5 percent by mass of CFx, LVO, carbon, and polyvinylidenefluoride, respectively,

While the invention has been shown and described with reference to certain embodiments of the present invention, it will be understood by those skilled in the art that various changes in from and details may be made to these embodiments without departing from the spirit and scope of the present invention and its equivalents.

What is claimed is:

1. A method of fabricating a composite cathode for use in high capacity batteries having partial rechargeability, comprising the steps of:
providing a first cathode active material that is rechargeable, and has a rechargeable voltage;
providing a second cathode active material that is high capacity, and has a high-capacity voltage that is lower than a rechargeable voltage of the first cathode active material; and
combining the first cathode active material and the second cathode active material to fabricate a composite cathode structure.

2. The method of claim 1, wherein the second cathode active material is non-rechargeable.

3. The method of claim 1, wherein the second cathode active material is rechargeable.

4. The method of claim 1, wherein the second cathode active material is non-rechargeable and the step of combining includes any of mixing, layering, coating, depositing, or patterning.

5. The method of claim 1, wherein the step of combining includes mixing to uniformly disperse the first and the second cathode active materials within the cathode structure.

6. The method of claim 1, wherein the step of combining includes patterning the first and second cathode active materials in a form of respective regional domains within the cathode structure.

7. The method of claim 6, wherein the patterning includes organizing the respective regional domains through either a thickness or an area of the cathode structure.

8. The method of claim 6, wherein the patterning includes layering the first and the second active cathode materials.

9. The method of claim 1, wherein the rechargeable materials display high voltage and electrochemical reversibility.

10. The method of claim 9, wherein the rechargeable materials are based on multiple transition metals or anion types.

11. The method of claim 9, wherein the rechargeable materials include transition metal oxides, phosphates, pyrophosphates and silicates.

12. The method of claim 1, wherein the high capacity materials include transition metal sulfides, transition metal fluorides, sulfur, carbon monofluoride, transition metal oxides transition metal phosphates, transition metal pyrophosphates, and transition metal nitrides.

13. The method of claim 1, wherein the rechargeable material is LiV₃O₈ and the high capacity material is carbon mono fluoride, CFₓ

14. The method of claim 1, wherein the rechargeable material is V₂O₅ and the high-capacity material is iron disulfide, FeS₂.

15. The method of claim 1, wherein the rechargeable material is a manganese oxide, MnₓO_{y} (including α-MnO₂, hollandite, buserite, birnessite, todorokite, ramsdellite, and other related structures) and the high-capacity material is iron disulfide, FeS₂.

16. The method of claim 1, wherein the rechargeable material is LiNiₓMn_{y}Co_{z}O₂ and the high-capacity material is CFₓ.

17. A method for fabricating a high-reliability battery, comprising the steps of:
preparing a high capacity cathode structure with partial rechargeability according to claim 1;
forming the high-reliability battery with high capacity cathode structure with partial rechargeability; and
testing the high-reliability battery repeatedly over a specific voltage range and recharging where necessary to assure high capacity under full discharge.

18. The method for fabricating of claim 17, wherein the second cathode active material present in the battery has a high capacity at a lower voltage than the first cathode active material.

19. The method for fabricating of claim 18, wherein the second cathode active material is non-rechargeable.

20. The method of claim 17, wherein the testing includes cycling to verify one or more of battery function, proper battery construction and battery internal resistance.

21. The method of claim 17, wherein the second cathode active material is low voltage and wherein the testing includes discharging the second cathode active material so that it is not fully depleted, thereby interrogating the high capacity battery to ensure high reliability and high energy density therein.

22. A cathode for use in a high-reliability battery in order to enable the high-reliability battery to be pre-tested to ensure high reliability and high energy density, comprising:
a first cathode active material that is rechargeable, and has a rechargeable voltage; and
a second cathode active material that is high capacity, and has a high-capacity voltage that is lower than a rechargeable voltage of the first cathode active material;
wherein the first and the second cathode active material are combined to realize a cathode structure.

23. The cathode of claim 22, wherein the cathode structure may be cyclically charged and discharged without fully depleting the high capacity second cathode active material.

24. The cathode of claim 22, wherein the first and the second cathode active materials are patterned such that said materials are not uniformly dispersed, but are in regional domains.

25. The cathode of claim 24, wherein the regional domains are arranged throughout a thickness or area of the cathode structure.

26. The cathode of claim 25, wherein the first and second cathode active materials are arranged as layers, one atop another, of the cathode structure.

27. The cathode of claim 22, wherein the first cathode active material comprises one or more of the following: transition metal sulfides, transition metal fluorides, sulfur, carbon monofluoride, transition metal oxides transition metal phosphates, transition metal pyrophosphates, and transition metal nitrides.

28. The cathode of claim 22, wherein the second cathode active material comprises one or more of the following transition metal sulfides, transition metal fluorides, sulfur, carbon monofluoride, transition metal oxides transition metal phosphates, transition metal pyrophosphates, and transition metal nitrides.

29. A highly-reliable battery, comprising a cathode of claim 22.

30. The highly reliable battery of claim 29, adapted to be tested at the cathode prior to deployment, including implementing charge/discharge cycling, and deliver higher capacity than is possible for a rechargeable battery at deployment.

31. The highly reliable battery of claim 30, wherein an energy density is increased relative conventional and rechargeable batteries.
